(19) United States
(12) Patent Application Publication
(10) Pub. No.: US 2026/0178110 A1
(43) Pub. Date: Jun. 25, 2026

(54) ELECTRONIC DEVICE COMPRISING CONTROL CIRCUITRY TO REDUCE STANDBY POWER AND METHOD THEREOF

(71) Applicant: Samsung Electronics Co., Ltd., Suwon-si (KR)

(72) Inventors: Sungyong JOO, Suwon-si (KR); Sungbum JUNG, Suwon-si (KR)

(21) Appl. No.: 19/341,708

(22) Filed: Sep. 26, 2025

Related U.S. Application Data
(63) Continuation of application No. PCT/KR2025/014156, filed on Sep. 11, 2025.

(30) Foreign Application Priority Data
Dec. 23, 2024 (KR) 10-2024-0194448

(51) Int. Cl. G06F 1/3296

(52) U.S. Cl. CPC G06F 1/3296

(57) ABSTRACT

An electronic device includes power circuitry connected to a first port for receiving an alternating current signal, a wired interface configured to control one or more second ports configured to provide a power to an external electronic device based on a power signal of the power circuitry, a sensor, and control circuitry configured to control a switch using the sensor. The control circuitry is configured to control, based on the electronic device in an enabled state, the switch to cease providing of the power through the one or more second ports an event to switch a state of the electronic device from the enabled state to a standby state. The control circuitry obtains, while the electronic device is switched to the standby state based on the controlling of the switch, information from the sensor. The control circuitry controls, based on obtaining the information indicating detection of an external object from the sensor, the switch to resume providing the power through the one or more second ports.

### CROSS-REFERENCE TO RELATED APPLICATIONS

This application is a continuation of International Application No. PCT/KR2025/014156 designating the United States, filed on Sep. 11, 2025, in the Korean Intellectual Property Receiving Office and claiming priority to Korean Patent Application No. 10-2024-0194448, filed on Dec. 23, 2024, in the Korean Intellectual Property Office, the disclosures of each of which are incorporated by reference herein in their entireties.

### BACKGROUND

### Field

The disclosure relates to an electronic device including control circuitry for reducing a standby power and a method thereof.

### Description of Related Art

An electronic device may be configured to execute various functions using an alternating current signal provided from a power system. Based on a wired connection through a plug, the electronic device may receive the alternating current signal. In order to reduce a power consumption, the electronic device may be switched to a standby mode. In the standby mode, the electronic device may be configured to reduce or minimize a power received through the wired connection. In a case that many electronic devices are connected to the power system and all electronic devices are in standby modes, the power system should continuously generate a power by standby powers of each of the electronic devices.

The information described above may be provided as a related art for a purpose of helping understanding of the present disclosure. No assertion or determination is made as to whether any of the above-described descriptions may be applied as a prior art related to the present disclosure.

### SUMMARY

An electronic device according to an example embodiment may include power circuitry connected to a first port and configured to receive an alternating current signal. The electronic device may include a switch configured to control an electric connection between the first port and the power circuitry. The electronic device may include a wired interface configured to control one or more second ports configured to provide a power to an external electronic device based on a power signal of the power circuitry. The electronic device may include a sensor. The electronic device may include control circuitry configured to control the switch using the sensor. The control circuitry may be configured to control the electronic device to identify, based on the electronic device being in an enabled state, an event to switch a state of the electronic device from the enabled state to a standby state. The control circuitry may be configured to control the electronic device to control, based on identifying the event, control the switch to cease providing of the power through the one or more second ports. The control circuitry may be configured to control the electronic device to obtain, while the electronic device is switched to the standby state based on the controlling of the switch, information from the sensor. The control circuitry may be configured to control the electronic device to control, based on obtaining the information indicating detection of an external object from the sensor, the switch to resume providing the power through the one or more second ports.

In an example embodiment, a method of operating an electronic device may be provided. The electronic device may include power circuitry connected to a first port configured to receive an alternating current signal, a switch configured to control an electric connection between the first port and the power circuitry, a wired interface configured to control one or more second ports configured to provide a power to an external electronic device based on a power signal of the power circuitry, a sensor, and control circuitry configured to control the switch using the sensor. The method may include: identifying, based on the electronic device being in an enabled state, an event to switch a state of the electronic device from the enabled state to a standby state. The method may include controlling, based on identifying the event, the switch to cease providing of the power through the one or more second ports. The method may include obtaining, while the electronic device is switched to the standby state based on the controlling of the switch, information from the sensor. The method may include controlling, based on obtaining the information indicating detection of an external object from the sensor, the switch to resume providing the power through the one or more second ports.

A display device according to an example embodiment may include: power circuitry configured to receive an alternating current signal. The display device may include a switch configured to control transmission of the alternating current signal to the power circuitry. The display device may include a battery configured to be charged based on a power signal output from the power circuitry in an enabled state. The display device may include a display configured to output an image based on the power signal. The display device may include a wired interface including one or more ports configured to output at least a portion of the power signal. The display device may include a sensor. The display device may include control circuitry configured to be driven based on the battery in a standby state different from the enabled state. The control circuitry may be configured to cause the display device to disable the power circuitry by controlling the switch to switch from the enabled state to the standby state. The control circuitry may be configured to cause the display device to, in the standby state that transmission of the power signal to the display and the wired interface is ceased based on the disabled power circuitry, obtain information from the sensor. The control circuitry may be configured to cause the display device to enable the power circuitry by controlling the switch based on obtaining the information indicating detection of an external object from the sensor.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example electronic device that receives a power from a power system according to various embodiments;

FIG. 2 is a block diagram illustrating an example configuration of an electronic device including a switch included in an electronic device to reduce a standby power and control circuitry of the switch according to various embodiments;

FIG. 3 is a flowchart illustrating an example operation of control circuitry included in an electronic device according to various embodiments;

FIG. 4 is a graph illustrating example timing of control circuitry for obtaining information from a sensor according to various embodiments; and

FIG. 5 is a diagram illustrating an example of an electronic device that charges a battery using a thermoelectric element according to various embodiments.

### DETAILED DESCRIPTION

Hereinafter, various example embodiments of the present disclosure will be described with reference to the accompanying drawings.

The various example embodiments of the present disclosure and terms used herein are not intended to limit the technology described in the present disclosure, and should be understood to include various modifications, equivalents, or substitutes. In relation to the description of the drawings, a reference numeral may be used for a similar component. A singular expression may include a plural expression unless it is clearly meant differently in the context. In the present disclosure, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, are only used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the present disclosure may include a unit configured with hardware, software, or firmware, and may be used interchangeably with terms such as logic, logic block, component, or circuit, and the like. The module may be an integrally configured component or a minimum unit or part thereof that performs one or more functions. For example, a module may be configured with an application-specific integrated circuit (ASIC).

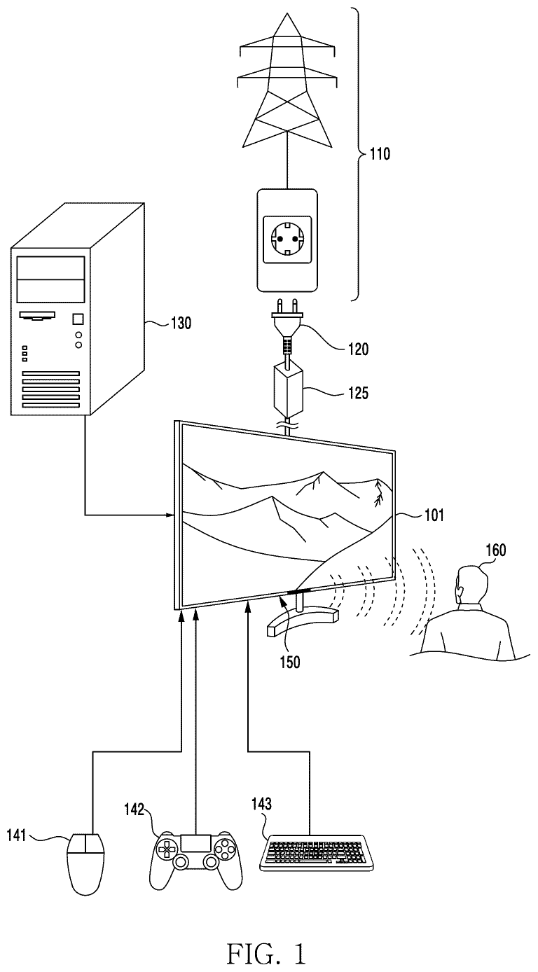

FIG. 1 is a diagram illustrating an example electronic device 101 that receives a power from a power system 110 according to various embodiments. The electronic device 101 may be described as an electronic device capable of displaying an image. For example, the electronic device 101 may be a monitor configured to visualize information received from a personal computer (PC) 130. In the present disclosure, the electronic device 101 may be referred to as the monitor and/or a display device.

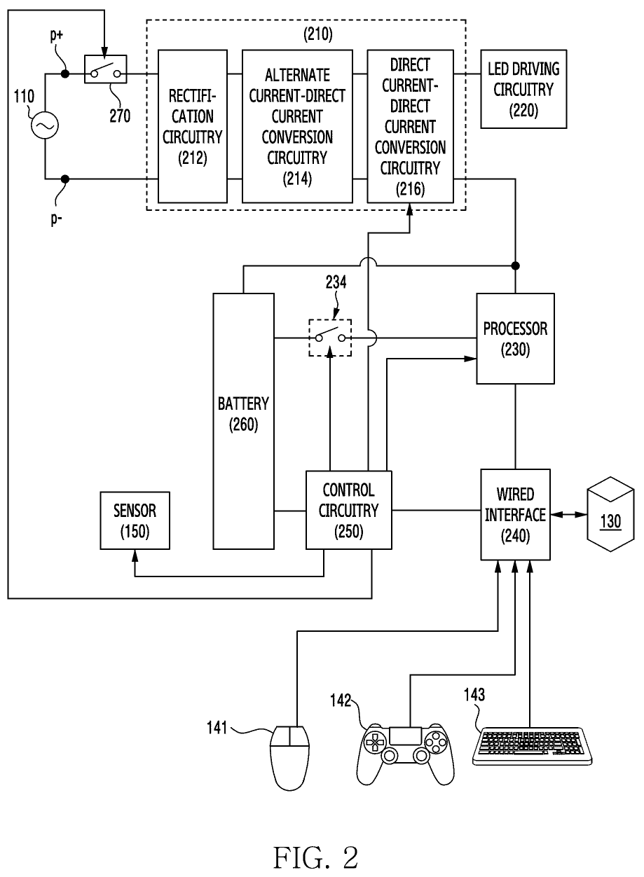

The electronic device 101 according to an embodiment may be configured to operate by a power (e.g., an alternating current (AC) power signal and/or an alternating current signal) provided from the power system 110. The power system 110 (or a distribution system) may be described as an infrastructure constructed to provide the power. The electronic device 101 may include a plug 120 (or a port and an electric cord) configured to be connected to an outlet (or an outlet, a socket, and a receptacle) positioned at an end of the power system 110. The plug 120 may be connected with a component (e.g., an AC-DC adapter (or an electric adapter 125) and/or power circuitry 210 described later with reference to FIG. 2) of the electronic device 101 for a power conversion (e.g., a power conversion from the AC signal to a direct current (DC) signal (or a direct current power signal)).

While the plug 120 is electrically connected with the power system 110, the electronic device 101 may execute a function for outputting an image, sound, or a combination (e.g., multimedia content) thereof based on the power of the power system 110. When the electronic device 101 receives information indicating the image and/or the sound, the electronic device 101 may execute the function using the information. The information indicating the image and/or the sound may be received from an external electronic device (e.g., the PC 130) connected to the electronic device 101.

The electronic device 101 may include a display panel configured to output an image. A surface of the electronic device 101 that may be visible by the display panel may be described as a front surface (e.g., a front side) of the electronic device 101. The display panel may include a liquid crystal display (LCD), a plasma display panel (PDP), and a plurality of LEDs. The LED of the display panel may include an organic LED (OLED). In an embodiment, the display panel may include electronic paper. In a case that the display panel has a planar shape, the display panel may be referred to as a flat panel display (FPD). In a case that the display panel has a curved shape, the display panel may be referred to as a curved display. In a case that the display panel has a deformable shape, the display panel may be referred to as a bendable display, a flexible display, and/or a rollable display.

The electronic device 101 while receiving the power of the power system 110 through the plug 120 may be driven according to any one of a normal mode (or an active mode and an enabled mode), a standby mode (or an inactive mode, a disabled mode, a hibernate mode, and a sleep mode), and a power-off mode. A mode of the electronic device 101 is not limited to the normal mode, the standby mode, and the power-off mode. In the present disclosure, a term “mode” may be used interchangeably with a term “state”. For example, the normal mode may be referred to as the enabled state, the standby mode may be referred to as a standby state, and the power-off mode may be referred to as a power-off state.

The normal mode may be a mode that consumes a power exceeding a power consumption (e.g., a standby power) of the standby mode to output an image. In the normal mode, at least a portion (e.g., back-light) of the display panel of the electronic device 101 may be enabled. While receiving a signal indicating an image from the external electronic device such as the PC 130, the electronic device 101 may output the image in the normal mode. While in the normal mode, the electronic device 101 may enter the standby mode in a case of having not received the image from the external electronic device for a specific period of time, and/or in a case of receiving, from the external electronic device, a signal indicating switching to the standby mode.

In the standby mode, an output of an image and/or an output of sound by the electronic device 101 may be substantially ceased, or may be minimized/reduced. While in the standby mode, the electronic device 101 may enter the normal mode based on receiving a signal indicating an image from the external electronic device, receiving, from the external electronic device, a signal indicating switching to the normal mode, and/or detecting an approach of a user 160 toward the electronic device 101.

While in the normal mode or the standby mode, the electronic device 101 may enter the power-off mode based on receiving a turn-off input (e.g., an input of pressing a power button of the electronic device 101 and/or an input of tapping a portion of a housing of the electronic device 101). While in the power-off mode, the electronic device 101 may not respond to another input different from a turn-on input (e.g., an input of pressing the power button of the electronic device 101, and/or an input of tapping a portion of the housing of the electronic device 101). In the power-off mode, based on receiving the turn-on input, the electronic device 101 may enter the normal mode and/or the standby mode.

A maximum power consumption of the electronic device 101 in each of modes of the electronic device 101 including the normal mode, the standby mode, and the power-off mode may be standardized as illustrated in Table 1.

TABLE 1

| | | Maximum value of power |
|---|---|---|
| Mode name | | consumption (unit: Watt (W)) |
| Power-off mode | | 0.5 |
| Standby | Digital visual interface (DVI) | 0.5 |
| mode | D-subminiature (D-Sub) | 0.5 |

| | |
|---|---|
| Normal mode | N/A |

The standby mode in Table 1 may be referred to as a display power management signaling (DPMS) mode. Referring to Table 1, the electronic device 101 may be designed to have a power consumption of equal to or less than 0.5 W in the standby mode, in a state of being connected with the external electronic device through any one interface among a DVI or a D-Sub.

In an embodiment, in order to (automatically) reduce a power consumption while the electronic device 101 is turned on, the standby mode may be defined. As described above, in the normal mode, in a case of having not received the signal indicating the image from the external electronic device for a period of time exceeding a preset period of time, and/or in a case of receiving, from the external electronic device, the signal indicating switching to the standby mode, the electronic device 101 may switch to the standby mode.

In the standby mode, the electronic device 101 may detect or identify an external object (e.g., the user 160) that is moved to the electronic device 101 using a sensor 150. Referring to FIG. 1, an embodiment in which the sensor 150 is positioned on the front side of the electronic device 101 in which the display panel is disposed is illustrated. The sensor 150 may detect an external object positioned in a direction of the front side of the electronic device 101. Based on detecting an external object spaced apart from the electronic device 101 by a distance shorter than a preset distance using the sensor 150, the electronic device 101 may switch from the standby mode to the normal mode. A position of the sensor 150 is not limited to the position (e.g., the front side of the electronic device 101) illustrated in FIG. 1. For example, the sensor 150 may be included in a component of the electronic device 101 having mobility, such as an electric adapter 125. In the example, the sensor 150 may be positioned on a surface of the electric adapter 125. In the example, the electronic device 101 may detect or identify the user 160 adjacent to the electric adapter 125 using the sensor 150.

In the standby mode, the sensor 150 and remaining hardware of the electronic device 101 different from hardware for processing information provided from the sensor 150 may be turned off. For example, the power circuitry and/or the display panel configured to generate a power signal for driving the remaining hardware using the AC signal received from the power system 110 may be turned off. In the standby mode, since the remaining hardware of the electronic device 101 including the power circuitry is turned off, a power consumption (e.g., the standby power) of the electronic device 101 measured in the power system 110 may be substantially reduced to 0 W. When switching from the standby mode to the normal mode, the electronic device 101 may turn on the power circuitry and/or the display panel again. A hardware structure of the electronic device 101 including the power circuitry, the display panel, and/or the sensor 150 will be described in greater detail below with reference to FIG. 2.

Referring to FIG. 1, the electronic device 101 may be connected with one or more external electronic devices. For example, the electronic device 101 may be connected with not only the PC 130 but also external electronic devices, such as a mouse 141, a game controller 142, and/or a keyboard 143. The electronic device 101 may be configured to relay data communication between the PC 130, the mouse 141, the game controller 142, and/or the keyboard 143. For example, the electronic device 101 may transmit a signal transmitted from the mouse 141, the game controller 142, and/or the keyboard 143 to the PC 130. For example, the electronic device 101 may transmit a signal transmitted from the PC 130 to at least one of the mouse 141, the game controller 142, or the keyboard 143.

In order to be connected with one or more external electronic devices, the electronic device 101 may include a wired interface. For example, the electronic device 101 may include port(s) based on a universal serial bus (USB), a display port (DP), a high-definition multimedia interface (HDMI), a communication port (COM), a DVI, and/or a D-SUB. In a state of being connected with the PC 130, the electronic device 101 may relay data communication between the PC 130 and an external electronic device connected through the port(s). In terms of relaying the data communication, the electronic device 101 may be referred to as a hub device. The electronic device 101 may transmit a power signal for driving the external electronic device to the external electronic device connected through the port(s). In other words, a power consumption of the electronic device 101 may be a sum of a power consumption in the external electronic device connected through the port(s) and the power consumption of the electronic device 101 itself. In an embodiment, in order to reduce the power consumption in the standby mode, the electronic device 101 may at least temporarily cease transmitting the power signal to the external electronic device connected through the port(s) while in the standby mode. The electronic device 101 may switch from the standby mode to the normal mode using the sensor 150 before an explicit input of the user 160 controlling the keyboard 143 and/or the mouse 141.

Even though an example in which the electronic device 101 is the monitor is described, the disclosure is not limited thereto, and any electronic device (e.g., a television (TV), a computer, a smartphone, a tablet PC, a portable media player, a wearable device, a video wall, an electronic frame, and the like) configured to provide a power to the external electronic device may perform an operation of the electronic device 101 of the present disclosure.

FIG. 2 is a block diagram illustrating an example configuration of an electronic device 101 including a switch 270 to reduce a standby power and control circuitry 250 of the switch 270 according to various embodiments. The electronic device 101 of FIG. 2 may include the electronic device 101 of FIG. 1. Referring to FIG. 2, a schematic diagram of a portion of circuitry of the electronic device 101 illustrated as blocks is illustrated. The electronic device 101 according to an embodiment may include power circuitry 210, a light emitting diode (LED) driving circuitry 220, a processor (e.g., including processing circuitry) 230, a wired interface 240, the control circuitry 250, a battery 260, a sensor 150, or any combinations thereof. Portions of circuitry of the electronic device 101 illustrated as the blocks may be electrically and/or operably connected by a power line and/or a communication bus. The electronic device 101 may further include other circuitry (e.g., a display panel, and/or a speaker) different from the circuitry illustrated in FIG. 2. The electronic device 101 may include only some of the circuitry illustrated as the blocks of FIG. 2.

Referring to FIG. 2, the power circuitry 210 of the electronic device 101 may include rectification circuitry 212, alternating current-direct current conversion circuitry 214, and/or direct current-direct current conversion circuitry 216. Even though not illustrated, the power circuitry 210 may further include lightning protection circuitry, a varistor, a surge arrester, an electromagnetic interference (EMI) filter, power factor conversion circuitry, or any combination thereof. The power circuitry 210 may be electrically connected with the power system 110 through a port (e.g., a port including nodes p+ and p−). For example, the power circuitry 210 may be connected to the port for receiving an AC current signal. Using the AC current signal received through the port, the power circuitry 210 may generate or output a power signal for driving the electronic device 101 including the power circuitry 210.

In an embodiment, the power circuitry 210 may be included in the electronic device 101. The disclosure is not limited thereto. For example, at least a portion (e.g., the rectification circuitry 212 and/or the AC-DC conversion circuitry 214) of the power circuitry 210 may be included in an electric adapter (e.g., the electric adapter 125 of FIG. 1) connected to the electronic device 101.

The rectification circuitry 212 of the power circuitry 210 may output a rectified AC signal by rectifying the AC signal provided by the power system 110. For example, the rectification circuitry 212 may be connected to the port (e.g., the port including the nodes p+ and p−) through the switch 270 to rectify the AC current signal. In order to rectify the AC current signal, the rectification circuitry 212 may include a plurality of diodes forming bridge circuitry. Half-wave rectification or full-wave rectification based on the plurality of diodes may be performed by the rectification circuitry 212. The disclosure is not limited thereto, and the rectification circuitry 212 may be implemented in a non-bridge method.

The AC-DC conversion circuitry 214 of the power circuitry 210 may be configured to output a DC signal from the AC current signal rectified by the rectification circuitry 212. For example, the AC-DC conversion circuitry 214 may include a capacitor charged by the rectified AC signal. The capacitor may be a circuit element that stores an electric energy based on an electric field. For example, the capacitor may include an electrolytic capacitor, a tantalum capacitor, a ceramic capacitor, and/or a film capacitor. The capacitor of the AC-DC conversion circuitry 214 may be referred to as a bulk capacitor and/or a super capacitor. When the capacitor is charged by the rectified AC current signal, a voltage between both ends of the capacitor may be smoothened.

The power circuitry 210 may include the DC-DC conversion circuitry 216 configured to output a plurality of DC signals from the AC current signal output from the AC-DC conversion circuitry 214. Each of the plurality of DC signals may have different voltages required for driving electronic components (e.g., load circuitry) included in the electronic device 101. The DC-DC conversion circuitry 216 may include inverter circuitry configured to output an AC signal from a DC signal output from the AC-DC conversion circuitry 214, and a plurality of inductors (e.g., coils, and an assembly of the coils) configured to receive the AC signal of the inverter circuitry. The plurality of inductors may include a primary coil that receives the AC signal of the inverter circuitry, and a secondary coil that is mutually coupled with the primary coil. Rectification circuitry and a capacitor connected to the secondary coil may be configured to output a DC signal required for driving an electronic component connected to the secondary coil from an AC signal generated from the secondary coil.

Referring to FIG. 2, example electronic components (e.g., the LED driving circuitry 220 and/or the processor 230) of the electronic device 101 configured to receive DC signals output from the DC-DC conversion circuitry 216 are illustrated. The LED driving circuitry 220 may include circuitry for driving a light source of the electronic device 101, referred to as back-light. The LED driving circuitry 220 may maintain or change brightness (or luminance) of a plurality of LEDs (e.g., LEDs included in a back-light component) included in the electronic device 101. For example, the LED driving circuitry 220 may generate or change voltages and/or currents applied to each of the plurality of LEDs. The voltages and/or the currents may be determined by the processor 230. Even though not illustrated, the electronic device 101 may include the display panel that is driven based on the power signal of the power circuitry 210.

Even though not illustrated, the DC-DC conversion circuitry 216 may be electrically connected with one or more speakers configured to output a voice. The one or more speakers may be configured to output an audio signal (e.g., an audio signal synchronized with an image to be displayed through the display panel). The processor 230 included in the electronic device 101 may control the display panel and the one or more speakers substantially simultaneously to simultaneously output an image and sound associated with the image.

Referring to FIG. 2, the electronic device 101 according to an embodiment may include the processor 230 for driving another electronic component of the electronic device 101, such as the display panel and/or the one or more speakers. For driving the processor 230, the processor 230 may generate a DC signal of a preset voltage (e.g., 13 V) based on a power signal supplied from the DC-DC conversion circuitry 216. The DC signal of the preset voltage may be transmitted from the processor 230 to other circuitry (e.g., the wired interface 240). The processor 230 may obtain or process information (e.g., information received from the PC 130 of FIG. 1) input to the electronic device 101. The processor 230 may control the display panel using the information to output the image through the display panel. The processor 230 may control the one or more speakers using the information to output the sound through the one or more speakers. In the present disclosure, the processor 230 may be referred to as main circuitry, a main board, and/or primary circuitry. The processor 230 may be implemented or produced in a form of an integrated circuit (IC), such as a system on a chip (SOC).

In an embodiment, the processor 230 may include various processing circuitry and be configured to execute a function (e.g., various functions executable in a normal mode) of the electronic device 101. The function may include a function of outputting an image and/or a voice (e.g., an image and/or a voice provided from the PC 130). The function may include a function of controlling a parameter associated with the image and/or the voice displayed through the electronic device 101, such as brightness, contrast, a color temperature, a gamma, sharpness, a response speed, a screen ratio, and/or an audio volume. The disclosure is not limited thereto, and the function may include a multi-window and/or an on screen display (OSD). The processor 230 may include an electronic component for receiving a user input associated with the function. For example, the component may include communication circuitry (e.g., communication circuitry for transmitting and/or receiving an infrared (IR) signal) to communicate with a button, a switch, a joystick, a touch sensor, and/or a remote controller. The processor 230 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In order to receive the image and/or the voice from the external electronic device such as the PC 130, the electronic device 101 may include the wired interface 240. The wired interface 240 may be connected to one or more ports for transmission of a video and/or audio, such as a USB, a COM, an HDMI, a DP, a DVI, a D-SUB, and/or an auxiliary (AUX) port. The external electronic device (e.g., the PC 130) connected to the electronic device 101 to provide the image and/or the voice may be referred to as a source device. From an electric signal received from the PC 130 connected through the wired interface 240, the processor 230 of the electronic device 101 may obtain or extract information indicating the image and/or the voice. Using the obtained information, the processor 230 may play or output the image and/or the voice by controlling the display panel and/or the speaker. The wired interface 240 may include circuitry for data communication based on the one or more ports. The processor 230, may transmit the power signal provided from the DC-DC conversion circuitry 216 (or the power circuitry 210). The wired interface 240 may provide a power to the external electronic device based on the power signal of the power circuitry 210. For example, the one or more ports included in the wired interface 240 may be configured to provide the power to the external electronic device. While receiving the power signal, the wired interface 240 may be configured to perform an operation associated with the data communication.

The external electronic device that may be connected through the wired interface 240 is not limited to the PC 130, and a mouse 141, a game controller 142, and/or a keyboard 143 may be connected with the electronic device 101 through the wired interface 240. For the external electronic device (e.g., the mouse 141, the game controller 142, and/or the keyboard 143) that does not output the image and/or the voice, the electronic device 101 may support or relay data communication between the external electronic device and the source device (e.g., the PC 130).

For example, the electronic device 101 may transmit or relay an electric signal transmitted from the external electronic device to the source device. In a case that the external electronic device is the mouse 141, the electric signal may include an electric signal indicating a user input such as movement and/or click of the mouse 141. In a case that the external electronic device is the game controller 142, the electric signal may include an electric signal indicating a user input to button(s) and/or a joystick included in the game controller 142. In a case that the external electronic device is the keyboard 143, the electric signal may include an electric signal indicating a user input (e.g., pressing a button) to at least one button of the keyboard 143. The source device (e.g., the PC 130) that has received the electric signal relayed by the electronic device 101 may detect or identify a user input based on the external electronic device using the electric signal.

The processor 230 may switch from the normal mode to a mode (e.g., a standby mode and/or a power-off mode) different from the normal mode. For example, in a case of having not received the image and/or the voice from the source device (e.g., the PC 130) connected through the wired interface 240, the processor 230 may switch a mode of the electronic device 101 including the processor 230 from the normal mode to the standby mode. The processor 230 may switch the mode of the electronic device 101 from the normal mode to the standby mode based on identifying of having not received the image and/or the voice from the source device for a period of time exceeding a preset period of time. In an embodiment, the processor 230 may switch from the normal mode to the standby mode based on a signal received from the PC 130 through the wired interface 240 and indicating switching to the standby mode.

For example, based on determining to switch from the normal mode to the standby mode, the processor 230 may disable (e.g., turn-off) the LED driving circuitry 220 and/or the display panel connected to the LED driving circuitry 220. The processor 230 may control the LED driving circuitry 220 to reduce a voltage of a power signal transmitted from the LED driving circuitry 220 to the display panel to a voltage (e.g., approximately 0 V) for disabling the display panel. The processor 230 may cease transmitting a power signal from the power circuitry 210 to other circuitry (e.g., the LED driving circuitry 220 and/or the processor 230) by controlling the power circuitry 210. For example, the processor 230 may at least partially disable (e.g., turn-off) the power circuitry.

The electronic device 101 according to an embodiment may include the control circuitry 250 configured to detect an external object using the sensor 150. The control circuitry 250 may determine whether a condition for switching from the standby mode to the normal mode is satisfied while the electronic device 101 (or the processor 230) is in the standby mode. The electronic device 101 may include the sensor 150 configured to output data associated with an external object (e.g., the user 160 of FIG. 1) (adjacent to the electronic device 101). The control circuitry 250 may determine whether to switch the mode of the electronic device 101 from the standby mode to the normal mode using the sensor 150. The control circuitry 250 may be implemented as a microcontroller unit (MCU) and/or an IC.

In an embodiment, when switching from the normal mode to the standby mode, the processor 230 may initiate an operation for detecting the external object (e.g., the user 160 of FIG. 1) using the sensor 150 using the control circuitry 250. The processor 230 may transmit a signal indicating switching from the normal mode to the standby mode to the control circuitry 250. For example, the control circuitry 250 may identify an event (e.g., an event indicated by the signal) for switching the mode of the electronic device 101 from the normal mode to the standby mode based on the electronic device 101 in the normal mode. Based on the signal, the control circuitry 250 may determine whether to switch from the standby mode to the normal mode using the data received from the sensor 150.

For example, based on the signal, the control circuitry 250 may initiate receiving the data from the sensor 150. For example, based on the signal, the control circuitry 250 may initiate processing the data. For example, based on the signal, the control circuitry 250 may detect or determine a distance between the electronic device 101 and the external object. For example, based on the signal, the control circuitry 250 may determine whether to switch the mode of the electronic device 101 from the standby mode to the normal mode by comparing a threshold distance with the distance.

In an embodiment, the electronic device 101 may include the switch 270 configured to control an electric connection between the power circuitry 210 and the port (e.g., the port including the nodes p+ and p−). The switch 270 may be configured to establish or disconnect the electric connection by adjusting a physical contact of a conductive structure (e.g., based on movement of the conductive structure). For example, the switch 270 may include an electronic component referred to as a relay, a relay switch, relay circuitry, and/or a latching relay.

In an embodiment, the electronic device 101 may include the control circuitry 250 configured to generate a control signal for controlling an electric connection (an electric connection between the node p+ and the rectification circuitry 212 of the power circuitry 210 in an embodiment of FIG. 2) in the switch 270. Based on identifying that the electronic device 101 is switched from the normal mode to the standby mode, and/or based on receiving, from the processor 230, a signal indicating switching to the standby mode, the control circuitry 250 may disconnect the electric connection (e.g., the electric connection between the node and the power circuitry 210) established in the switch 270 by controlling the switch 270. For example, based on identifying the event to switch the mode of electronic device 101 from the normal mode to the standby mode, the control circuitry 250 may control the switch 270 to cease providing of a power through the port. For example, in order to reduce a power consumption of remaining circuitry including the display panel based on identifying the event, the control circuitry 250 may disconnect the electric connection between the port (e.g., the port including the nodes p+ and p−) and the power circuitry 210 by controlling the switch 270.

Since the electric connection in the switch 270 is disconnected after the electronic device 101 is switched to the standby mode, the power consumption of the electronic device 101 measured in the power system 110 may be substantially reduced to 0 W. The power circuitry 210 may not transmit any power signal to other circuitry of the electronic device 101 based on the disconnected electric connection. For example, the LED driving circuitry 220 connected to the power circuitry 210 (and the display panel connected to the LED driving circuitry 220), the processor 230, and the wired interface 240 may not receive any power signal after the electronic device 101 is switched to the standby mode. Since the wired interface 240 does not receive any power signal, a power may not be provided to the external electronic device connected to the wired interface 240. Another external electronic device (e.g., the mouse 141, the game controller 142, and/or the keyboard 143) connected to the electronic device 101 to receive a power from the electronic device 101 different from the external electronic device (e.g., the PC 130) connected to the power system 110 independently of the electronic device 101 may be substantially disabled (e.g., turned-off) after electronic device 101 is switched to the standby mode.

In an embodiment, the electronic device 101 may include the sensor 150. The sensor 150 may include a sensor (e.g., a proximity sensor) for detecting the external object (e.g., the user 160 of FIG. 1) adjacent to the electronic device 101. While the electronic device 101 is in the standby mode, the control circuitry 250 of the electronic device 101 may be configured to control the switch 270 using the sensor 150.

The electronic device 101 according to an embodiment may include the battery 260 configured to provide a power to the control circuitry 250, the sensor 150, and/or the switch 270 in the standby mode of the electronic device 101. The battery 260 may be a rechargeable battery. The battery 260 may output, from a chemical energy, an electric energy required for driving an electronic component (e.g., the control circuitry 250, the sensor 150, and/or the switch 270) of the electronic device 101. The battery 260 may include a battery cell, a battery module, or a battery pack. The battery 260 may be any one of a lithium ion (Li-ion) battery, a lithium ion polymer (Li-ion polymer) battery, a lead storage battery, a nickel-cadmium (NiCd) battery, and a nickel hydrogen (NiMH) storage battery. The disclosure is not limited thereto, and the battery 260 may include a capacitor (e.g., a capacitor having a relatively high capacitance, referred to as a super capacitor). The battery 260 may be charged based on the power signal of the power circuitry 210 while the electronic device 101 is in the normal mode. For example, the battery 260 may be charged based on the power signal output from the power circuitry 210 in the normal mode. The battery 260 may provide the power to the control circuitry 250, the sensor 150, and/or the switch 270 while the electronic device 101 is in the standby mode.

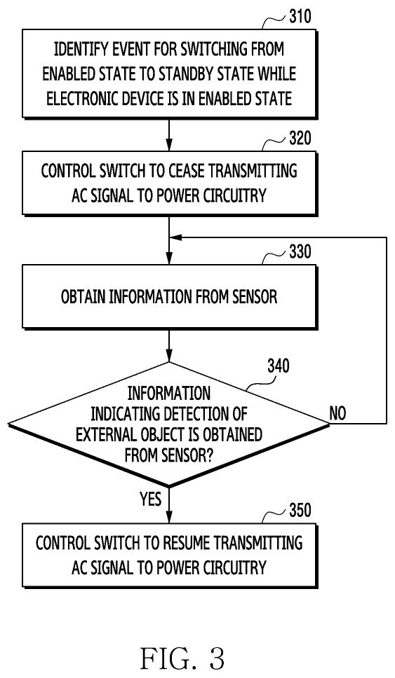

While the electronic device 101 is switched to the standby mode based on control of the switch 270, the control circuitry 250 may obtain information from the sensor 150 enabled based on the power of the battery 260. Using the information obtained from the sensor 150, the control circuitry 250 may control the switch 270. For example, based on obtaining information indicating detection of the external object from the sensor 150, the control circuitry 250 may establish the electric connection between the port and the power circuitry 210 by controlling the switch 270. For example, the control circuitry 250 may establish the electric connection by controlling the switch 270 to enable other hardware of the electronic device 101 including the processor 230. For example, the control circuitry 250 may establish the electric connection by controlling the switch 270 to enable the external electronic device (e.g., the mouse 141, the game controller 142, and/or the keyboard 143) connected to port(s) of the wired interface 240. For example, the control circuitry 250 may control the switch 270 to resume providing a power through the port(s) of the wired interface 240. An example operation in which the control circuitry 250 controls the switch 270 using information obtained from the sensor 150 while in the standby mode of the electronic device 101 will be described in greater detail below with reference to FIGS. 3 and/or 4.

As an operation performed by the control circuitry 250, an operation of processing the information obtained from the sensor 150 has been illustrated, but the disclosure is not limited thereto. For example, the control circuitry 250 may measure a state of charge (SOC) and/or a battery cycle of the battery 260. The control circuitry 250 may establish the electric connection in the switch 270 at least temporarily by controlling the switch 270, in a case that the SOC and/or a voltage (e.g., an open circuit voltage (OCV)) of the battery 260 is decreased to less than a preset SOC and/or a preset voltage while the electronic device 101 is in the standby mode. Using the power signal transmitted from the power circuitry 210 enabled by the electric connection, the battery 260 may be at least temporarily charged. In a case that the SOC of the battery 260 increases to the preset SOC or more based on the charging of the battery 260, the control circuitry 250 may disconnect the electric connection by controlling the switch 270.

As described above, the electronic device 101 according to an embodiment may conditionally switch from the standby mode to the normal mode using circuitry (e.g., the battery 260, the control circuitry 250, and/or the sensor 150) electrically insulated from the power system 110 in the standby mode. Even though an example in which the battery 260 provides the power to the control circuitry 250, the sensor 150, and/or the switch 270 in the standby mode has been described, the disclosure is not limited thereto. For example, a switch 234 for controlling an electric connection between the battery 260 and the processor 230 may be further included in the electronic device 101. The control circuitry 250 may transmit the power of the battery 260 to the processor 230 at least temporarily by controlling the switch 234. In the standby mode, the processor 230 may be enabled based on the power of the battery 260. In the standby mode, since the entire power circuitry 210 including the rectification circuitry 212 is electrically insulated from the power system 110, a standby power of the electronic device 101 may be substantially decreased to 0 W in terms of the power system 110. For example, in the standby mode, the electronic device 101 may perform an operation of switching from the standby mode to the normal mode while reducing the power consumption associated with the power system 110 to 0 W.

FIG. 3 is a flowchart illustrating an example operation of control circuitry included in an electronic device according to various embodiments. The electronic device of FIG. 3 may include the electronic device 101 of FIGS. 1 and/or 2. The control circuitry of FIG. 3 may include the control circuitry 250 of FIG. 2. The control circuitry 250 of FIG. 2 may perform operations of FIG. 3 in an order illustrated in FIG. 3 and/or in another order different from the order. For example, the operations of FIG. 3 may be performed in another order different from the order illustrated in FIG. 3. For example, at least two operations of the operations of FIG. 3 may be performed substantially simultaneously.

Referring to FIG. 3, in operation 310, the control circuitry of the electronic device according to an embodiment may identify an event for switching from an enabled state to a standby state while the electronic device is in the enabled state. The event may occur based on ceasing transmission of an image and/or a voice from an external electronic device (e.g., the source device such as the PC 130 of FIGS. 1 and/or 2), as described above with reference to FIGS. 1 and/or 2. The event may include receiving a signal causing switching to the standby state. The event may be identified by a processor (e.g., the processor 230 of FIG. 2) of the electronic device driven in the enabled state. The processor may transmit a signal indicating the event to the control circuitry based on identifying the event. While in the enabled state, a battery (e.g., the battery 260 of FIG. 2) of the electronic device may be charged.

Referring to FIG. 3, in operation 320, the control circuitry of the electronic device according to an embodiment may control a switch (e.g., the switch 270 of FIG. 2) to cease transmitting an AC signal to power circuitry (e.g., the power circuitry 210 of FIG. 2). For example, the control circuitry may disconnect an electric connection between a power system (e.g., the power system 110 of FIGS. 1 and/or 2) and the power circuitry, established through the switch. When the electric connection is disconnected, a state of the electronic device may be switched from the enabled state to the standby state. When the electric connection is disconnected, remaining circuitry of the electronic device different from the control circuitry, including the processor and/or a display panel, may be disabled (e.g., turned-off). Since the electric connection in the power circuitry is disconnected, a power consumption of the electronic device after the operation 320 may be substantially decreased to 0 W. In a case that the electronic device includes a wired interface (e.g., the wired interface 240 of FIG. 2) such as a USB, an external electronic device that received a power through the wired interface may also be disabled (e.g., turned-off) by disconnection of the electric connection. For example, the electronic device may support a power control of the external electronic device.

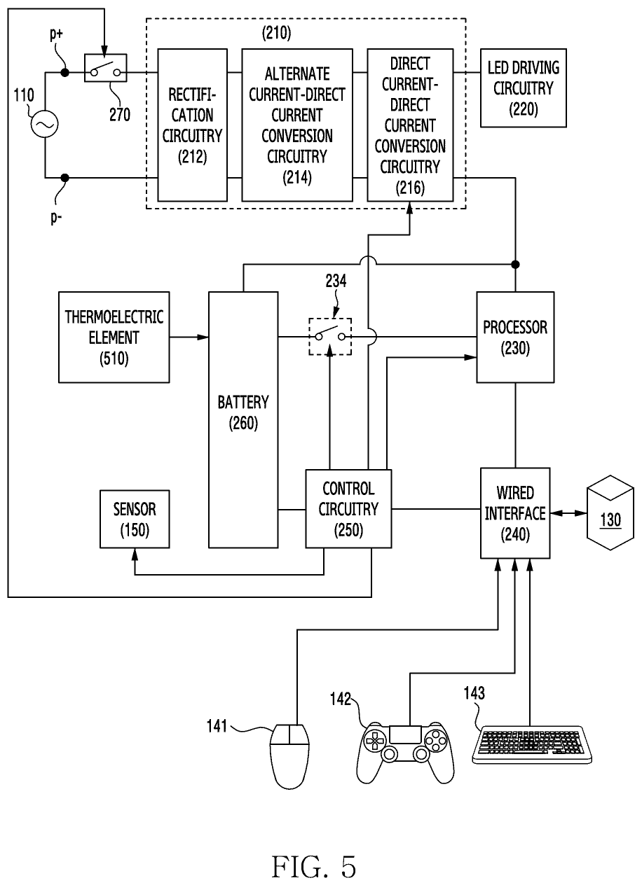

A portion of circuitry of the electronic device including the control circuitry may be enabled based on the battery (e.g., the battery 260 of FIG. 2) of the electronic device. For example, the electronic device may have a hybrid structure that may be driven using each of the battery and the power system. The battery may be charged while the electronic device is in the enabled state. The disclosure is not limited thereto, and the battery may be charged by an electric-energy (e.g., an electric-energy converted by an electronic component referred to as an energy harvester) converted from a non-electric energy (e.g., a thermal energy generated from an electronic component included in the electronic device). An embodiment including the battery charged based on the non-electric energy will be described in greater detail below with reference to FIG. 5.

Referring to FIG. 3, in operation 330, the control circuitry of the electronic device according to an embodiment may obtain information from a sensor (e.g., the sensor 150 of FIGS. 1 and/or 2). The control circuitry may periodically, repeatedly, continuously, and/or randomly enable the sensor while in the standby state. From the enabled sensor, the control circuitry may obtain or receive the information of the operation 330. The information in the operation 330 may include sensor data of the control circuitry.

Referring to FIG. 3, in operation 340, the control circuitry of the electronic device according to an embodiment may determine whether information indicating detection of an external object has been obtained from the sensor. In an embodiment including the sensor configured to detect the external object, a threshold distance detectable by the sensor may be determined according to sensitivity of the sensor. When an external object such as the user 160 of FIG. 1 is moved toward the electronic device (or the sensor), the information obtained from the sensor may be changed by the external object in a case that the external object is spaced apart from the electronic device (or the sensor) by a distance shorter than the threshold distance. Based on identifying the information changed by the external object, the control circuitry may identify or detect the external object. Based on obtaining the information indicating detection of the external object (340—YES), the control circuitry may perform operation 350. When not obtaining the information indicating the detection of the external object, and/or prior to obtaining the information indicating the detection of the external object (340—NO), the control circuitry may repeatedly, periodically, and/or continuously perform the operation 330. For example, based on the operations 330 and 340, the control circuitry may detect or monitor the external object.

Referring to FIG. 3, in the operation 350, the control circuitry of the electronic device according to an embodiment may control the switch to resume transmission of the AC signal to the power circuitry. For example, the control circuitry may control the switch to resume providing a power to an external electronic device connected with the electronic device through one or more ports, based on obtaining the information indicating the detection of the external object spaced apart from the electronic device by a distance shorter than a threshold distance from the sensor. For example, the control circuitry may control the switch to enable the power circuitry and remaining circuitry of the electronic device included in the power circuitry. For example, the control circuitry may establish the electric connection between the power system and the power circuitry using the switch. Based on the electric connection, the remaining circuitry of the electronic device including the processor may be enabled.

In an embodiment, the control circuitry may transmit, to the processor, a signal causing switching from the standby state to the enabled state. Based on the signal, the processor of the electronic device may perform an operation for switching to the enabled state. For example, the processor may disable (e.g., turn-off) the control circuitry and/or the sensor. For example, the processor may relay (again) data communication between external electronic devices through the wired interface. For example, the processor may resume charging the battery of the electronic device.

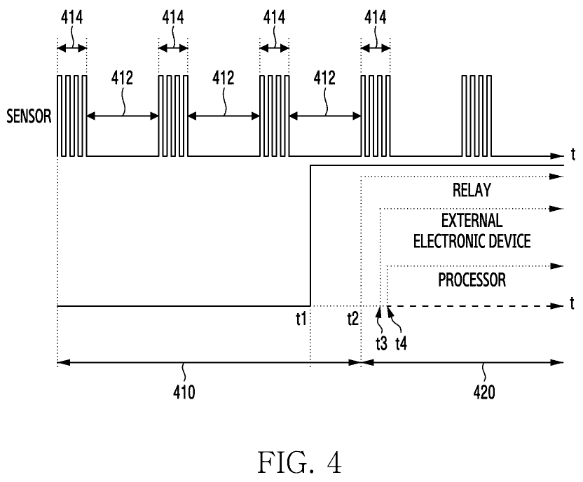

Hereinafter, an example operation of the electronic device that obtains the information from the sensor based on the operations 330 and 340 will be described in greater detail with reference to FIG. 4.

FIG. 4 is a graph illustrating example timing of control circuitry (e.g., the control circuitry 250 of FIG. 2) for obtaining information from a sensor (e.g., the sensor 150 of FIGS. 1 and/or 2) according to various embodiments. Referring to FIG. 4, a graph for describing a state of electronic components included in the electronic device 101 of FIGS. 1 and/or 2 is illustrated. The sensor 150 of FIG. 2 may include the sensor of FIG. 4. The switch 270 of FIG. 2 may include a relay of FIG. 4. The external electronic devices (e.g., the mouse 141, the game controller 142, and/or the keyboard 143) connected to the electronic device 101 illustrated in FIGS. 1 and/or 2 may include an external electronic device of FIG. 4. The processor 230 of FIG. 2 may include a processor of FIG. 4.

Referring to FIG. 4, an electronic device may operate in a standby mode in a first time interval 410. The electronic device may obtain information to be used to detect an external object (e.g., the user 160 of FIG. 1) adjacent to the electronic device by enabling at least temporarily the sensor. Referring to FIG. 4, the sensor may be disabled during a first sub-time interval 412. The electronic device may obtain information from the sensor by enabling the sensor during a second sub-time interval 414. In the first sub-time interval 412, the electronic device may set a voltage (e.g., a Vcc voltage) input to the sensor to a voltage (e.g., approximately 0 V) less than a threshold voltage for driving the sensor. In the second sub-time interval 414, the electronic device may set the voltage (e.g., the Vcc voltage) input to the sensor to a voltage equal to or greater than the threshold voltage.

Referring to FIG. 4, the sensor may be periodically enabled based on the first sub-time interval 412 and the second sub-time interval 414. The disclosure is not limited thereto, and the electronic device may continuously enable the sensor, may aperiodically enable the sensor, or may randomly enable the sensor.

Referring to FIG. 4, it is assumed that at a time point t1, a distance between a user and the electronic device is decreased to shorter than a threshold distance detectable by the sensor. Since the time point t1 is included in the first sub-time interval 412, at the time point t1, the sensor may be disabled. For example, since the sensor is disabled at the time point t1, the electronic device may not detect the user. At a time point t2 included in the second sub-time interval 414, the sensor may be enabled again. Using information obtained from the enabled sensor, at the time point t2, the electronic device may detect the user. For example, the control circuitry (e.g., the control circuitry 250 of FIG. 2) connected to the sensor may detect the user using the information of the sensor.

Based on detecting the user at the time point t2, the control circuitry may cause a state of the relay (e.g., the switch 270 of FIG. 2) to be in a preset state for enabling an electric connection (e.g., the electric connection between the node p+ and the rectification circuitry 212 of FIG. 2) in the relay. In a second time interval 420 after the time point t2, the electronic device may switch from the standby mode to another mode (e.g., a normal mode) different from the standby mode. Based on the electric connection, at a time point t3 after the time point t2, an external electronic device connected to the electronic device may receive a power signal. Based on the electric connection, at a time point t4 after the time point t2, the processor (e.g., the processor 230 of FIG. 2) included in the electronic device may be enabled. Based on the enabled processor, the electronic device may execute an operation and/or a function of the normal mode. An order between the time point t3 and the time point t4 is not limited.

FIG. 5 is a block diagram illustrating an example configuration of an electronic device 101 that charges a battery 260 using a thermoelectric element 510 according to various embodiments. The electronic device 101 of FIGS. 1 and/or 2 may include the electronic device 101 of FIG. 5. The electronic device 101 of FIG. 5 may perform an operation of the electronic device described with reference to FIGS. 1 to 4.

The electronic device 101 of FIG. 5 may include power circuitry 210 configured to receive an AC signal, and a switch 270 configured to control transmission of the AC signal to the power circuitry 210, as described above with reference to FIGS. 1 to 4. The electronic device 101 may include a wired interface 240 including one or more ports configured to output at least a portion of a power signal output from the power circuitry 210. The electronic device 101 may include control circuitry 250 configured to be driven based on the battery 260 in a standby mode different from a normal mode. Among a description of the electronic device 101 of FIG. 5, a description overlapping a description of the electronic device of FIGS. 1 to 4 may not be repeated here.

The control circuitry 250 may disable the power circuitry 210 by controlling the switch 270 to switch from the normal mode to the standby mode. In the standby mode, in which transmission of a power signal to a display panel, a processor 230, and/or the wired interface 240 is ceased based on the disabled power circuitry 210, the control circuitry 250 may obtain information from the sensor 150. The control circuitry 250 may enable the power circuitry 210 by controlling the switch 270 based on obtaining information indicating detection of an external object from the sensor 150. The power circuitry 210 may include rectification circuitry 212 configured to rectify an AC signal transmitted from a power system 110. The rectification circuitry 212 may receive the AC signal through the switch 270. In the standby mode, since the power circuitry 210 is disabled by the switch 270, the entire power circuitry 210 including the rectification circuitry 212 may be disabled.

Referring to FIG. 5, the electronic device 101 may include the thermoelectric element 510. In an embodiment, the thermoelectric element 510 may be attached to the display panel to change a thermal energy generated by the display panel of the electronic device 101 to an electric energy. For example, the thermoelectric element 510 may be attached to a surface of LEDs (e.g., an LED strip) included in the display panel to provide back-light. For example, the thermoelectric element 510 may be attached to the power circuitry 210 (e.g., a transformer of the power circuitry 210 and/or a core of the transformer) of the processor 230 and/or the electronic device 101. For example, the thermoelectric element 510 may be attached to any component that generates heat in the electronic device 101.

The battery 260 may be configured to store an electric energy generated from the thermoelectric element 510. The number of thermoelectric element 510 included in the electronic device 101 may be one or more. In an embodiment in which the electronic device 101 includes a plurality of thermoelectric elements including the thermoelectric element 510, the plurality of thermoelectric elements may be coupled in series with each other. A potential difference and/or a current between electrodes of the thermoelectric element may be generated by a temperature difference between two opposite surfaces of the thermoelectric element. In a case that the thermoelectric elements are coupled in series with each other, a power signal having a composite voltage in which potential differences of the thermoelectric elements are coupled may be generated. The battery 260 may be charged based on the power signal.

Even though the thermoelectric element 510 has been illustrated as an example of an electronic component that generates an electric energy from a non-electric energy, the electronic component included in the electronic device 101 to charge the battery 260 is not limited thereto. For example, in order to charge the battery 260, the electronic device 101 may include an element that generates an electric energy from an energy (e.g., a thermal energy) different from the electric energy, referred to as an energy harvester. The energy harvester may include a piezoelectric element based on a piezoelectric effect, a magnetoelectric element based on a magnetoelectric effect, and/or a piezoelectric element based on a photovoltaic effect.

In order to control charging of the battery 260 based on the thermoelectric element 510, the electronic device 101 may include charging circuitry. In an embodiment in which the electronic device 101 includes the plurality of thermoelectric elements coupled in series with each other, including the thermoelectric element 510, the charging circuitry may receive the power signal having the composite voltage of voltages generated from the plurality of thermoelectric elements. Since the voltage of the thermoelectric element 510 and/or a flow of a current generated by the thermoelectric element 510 are relatively small, the charging circuitry may output a voltage and/or a current having a suitable size to charge the battery 260 from the voltage and/or the current. For example, the charging circuitry may be configured to control charging of the battery 260 based on a power generated from the thermoelectric element 510 Using the power signal, the charging circuitry may determine or change a voltage and/or a current to be transmitted to the battery 260 of the electronic device 101. For example, the charging circuitry may be configured to adjust a current input to the battery 260 to maintain generation of a power in the thermoelectric element 510. For example, the charging circuitry may limit the current of the power signal to be transmitted to the battery 260 so that current flow of the thermoelectric element 510 is not ceased. In an enabled state, the battery 260 may be charged by heat generated from an electronic component (e.g., the display panel) to which the thermoelectric element 510 is attached.

In an embodiment in which the battery 260 is charged based on the thermoelectric element 510, additional circuitry for charging the battery 260 using the power signal generated by the power circuitry 210 may not be included in the electronic device 101. For example, the electronic device 101 may be produced or implemented, without circuitry for converting the AC signal into a DC signal or charging the battery 260 using the converted DC signal. For example, since the electronic device 101 is implemented without additional rectification circuitry, a transformer, and/or protection circuitry (e.g., circuitry to protect the battery 260 from lightning) for charging the battery 260, the electronic device 101 may be implemented by adding relatively few electronic circuitry (e.g., the battery 260, the charging circuitry, and/or the thermoelectric element 510) while having a decreased standby power.

In an embodiment in which the battery 260 is charged based on the thermoelectric element 510, charging the battery 260 may be dependent on to a temperature of the electronic component to which the thermoelectric element 510 is attached. For example, charging the battery 260 may be performed independently of a mode (e.g., the standby mode, the normal mode, and/or a power-off mode) of the electronic device 101. For example, when the thermoelectric element 510 outputs a heat-based power signal, the battery 260 may be charged based on the power signal independently of the mode of the electronic device 101.

As described above, the electronic device 101 according to an embodiment may include the switch 270 for electrically being insulated from the power system 110 in the standby mode. While electrically being insulated from the power system 110 using the switch 270, the electronic device 101 may check a condition for resuming receiving the AC signal from the power system 110 using the control circuitry 250 and/or the sensor 150. Based on satisfying the condition, the electronic device 101 may be electrically connected with the power system 110 using the switch 270. Based on satisfying the condition, the electronic device 101 may switch from the standby mode to the normal mode. In the standby mode, in order to maintain (at least temporarily) enabling the control circuitry 250 and/or the sensor 150 regardless of electric insulation from the power system 110, the electronic device 101 may include the battery 260 configured to store the electric energy at least temporarily. Using the battery 260 charged in the normal mode, the electronic device 101 may provide the power to the control circuitry 250 and/or the sensor 150 in the standby mode.

In an embodiment, a method of reducing or removing a power consumption (e.g., a standby power) of an electronic device in a standby mode may be required. In an embodiment, a method of switching a mode of the electronic device from the standby mode to a normal mode may be required without receiving a power from the outside (e.g., a power system) in the standby mode. As described above, an electronic device according to an embodiment may include power circuitry connected to a first port for receiving an alternating current signal. The electronic device may include a wired interface configured to control one or more second ports configured to provide a power to an external electronic device based on a power signal of the power circuitry. The electronic device may include a sensor. The electronic device may include control circuitry configured to control the switch using the sensor. The control circuitry may be configured to identify, based on the electronic device in an enabled state, an event to switch a state of the electronic device from the enabled state to a standby state. The control circuitry may be configured to control, based on identifying the event, the switch to cease providing of the power through the one or more second ports. The control circuitry may be configured to obtain, while the electronic device is switched to the standby state based on the controlling of the switch, information from the sensor. The control circuitry may be configured to control, based on obtaining the information indicating detection of an external object from the sensor, the switch to resume providing the power through the one or more second ports. The electronic device according to an embodiment may reduce or remove the power consumption (e.g., the standby power) of the electronic device in the standby mode (e.g., the standby state) using the control circuitry. The electronic device according to an embodiment may switch from the standby mode to the normal mode without receiving the power from the outside (e.g., without receiving the alternating current signal) in the standby mode using control circuitry.

For example, the electronic device may include a battery configured to be charged based on the power signal of the power circuitry. The control circuitry may be configured to obtain the information using the power of the battery while the electronic device is in the standby state. Since the control circuitry is driven using the battery in the standby state, the power consumption in the standby state may be substantially reduced to 0 W.

For example, the electronic device may include a display panel that is driven based on the power signal of the power circuitry, and one or more thermoelectric elements that are attached to the display panel for changing a thermal energy generated by the display panel to an electric energy.

For example, the battery may be configured to store the electric energy generated from the one or more thermoelectric elements. Since the battery may be charged by the electric energy generated from the thermoelectric elements, the battery may be charged independently of the power transmitted from the power system.

For example, the one or more thermoelectric elements may be attached to a surface of light emitting diodes (LEDs) which are included in the display panel to provide back-light.

For example, the electronic device may include a display panel driven based on the power signal of the power circuitry. The control circuitry may be configured to disconnect, based on identifying the event, the electric connection between the first port and the power circuitry by controlling the switch to reduce a power consumption of the display panel.

For example, the control circuitry may be configured to establish, based on obtaining the information indicating detection of the external object from the sensor, the electric connection between the first port and the power circuitry by controlling the switch to enable the external electronic device connected to the one or more second ports.

For example, the control circuitry may be configured to control, based on obtaining the information indicating detection of the external object spaced apart from the electronic device by a distance shorter than a threshold distance from the sensor, the switch to resume providing the power through the one or more second ports.

For example, the switch may include a relay switch configured to establish or disconnect the electric connection based on movement of a conductive structure.

For example, the wired interface may be configured to relay data communication between external electronic devices connected to the second ports which are a universal serial bus (USB).

For example, the power circuitry may include rectification circuitry connected to the first port through the switch to rectify the alternating current signal.

In an embodiment as described above, a method of an electronic device may be provided. The electronic device may include power circuitry connected to a first port for receiving an alternating current signal, a switch configured to control an electric connection between the first port and the power circuitry, a wired interface configured to control one or more second ports configured to provide a power to an external electronic device based on a power signal of the power circuitry, a sensor, and control circuitry configured to control the switch using the sensor. The method may include identifying, based on the electronic device in an enabled state, an event to switch a state of the electronic device from the enabled state to a standby state. The method may include controlling, based on identifying the event, the switch to cease providing of the power through the one or more second ports. The method may include obtaining, while the electronic device is switched to the standby state based on the controlling of the switch, information from the sensor. The method may include controlling, based on obtaining the information indicating detection of an external object from the sensor, the switch to resume providing the power through the one or more second ports.

For example, the obtaining may include obtaining the information using the power of a battery of the electronic device that is configured to be charged based on the power signal of the power circuitry, while the electronic device is in the standby state.

For example, the battery may be configured to store an electric energy generated from one or more thermoelectric elements that are attached to a display panel for changing a thermal energy generated by the display panel of the electronic device to the electric energy.

For example, the controlling the switch to resume providing the power may include disconnecting, based on identifying the event, the electric connection between the first port and the power circuitry by controlling the switch to reduce a power consumption of the display panel of the electronic device.

For example, the controlling the switch to resume providing the power may include establishing, based on obtaining the information indicating detection of the external object from the sensor, the electric connection between the first port and the power circuitry by controlling the switch to enable the external electronic device connected to the one or more second ports.

For example, the controlling the switch to resume providing the power may include controlling, based on obtaining the information indicating detection of the external object spaced apart from the electronic device by a distance shorter than a threshold distance from the sensor, the switch to resume providing the power through the one or more second ports.

As described above, a display device according to an example embodiment may include power circuitry configured to receive an alternating current signal, a switch configured to control transmission of the alternating current signal to the power circuitry, a battery configured to be charged based on a power signal output from the power circuitry in an enabled state, a display configured to output an image based on the power signal, a wired interface including one or more ports configured to output at least a portion of the power signal, a sensor, and control circuitry configured to be driven based on the battery in a standby state different from the enabled state. The control circuitry may be configured to disable the power circuitry by controlling the switch to switch from the enabled state to the standby state. The control circuitry may be configured to, in the standby state that transmission of the power signal to the display and the wired interface is ceased based on the disabled power circuitry, obtain information from the sensor. The control circuitry may be configured to enable the power circuitry by controlling the switch based on obtaining the information indicating detection of an external object from the sensor.

For example, the power circuitry may include rectification circuitry configured to rectify the alternating current signal. The rectification circuitry may be configured to receive the alternating current signal through the switch.

For example, the switch may include a relay switch configured to establish or disconnect the electric connection based on movement of a conductive structure.

As used herein, the term “if” is, optionally, understood to refer, for example, to “when” or “upon” or “in response to determining” or “in response to detecting,” depending on the context. Similarly, the phrase “if it is determined” or “if [a stated condition or event] is detected” is, optionally, understood to refer, for example, to “upon determining” or “in response to determining” or “upon detecting [the stated condition or event]” or “in response to detecting [the stated condition or event],” depending on the context.

The device described above may be implemented as a hardware component, a software component, and/or a combination of a hardware component and a software component. For example, the devices and components described in the disclosure may be implemented using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible. Thus, the processor or processing device may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to an embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the disclosure has been illustrated and described above with reference to various examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

What is claimed is:

1. An electronic device comprising:
power circuitry connected to a first port configured to receive an alternating current signal;
a switch configured to control an electrical connection between the first port and the power circuitry;
a wired interface configured to control one or more second ports configured to provide a power to an external electronic device based on a power signal of the power circuitry;
a sensor; and
control circuitry configured to control the switch using the sensor,
wherein the control circuitry is configured to cause the electronic device to:
identify, based on the electronic device in an enabled state, an event to switch a state of the electronic device from the enabled state to a standby state;
control, based on identifying the event, the switch to cease providing power through the one or more second ports;
obtain, while the electronic device is switched to the standby state based on the controlling of the switch, information from the sensor; and
control, based on obtaining the information indicating detection of an external object from the sensor, the switch to resume providing the power through the one or more second ports.

2. The electronic device of claim 1, further comprising:
a battery configured to be charged based on the power signal of the power circuitry,
wherein the control circuitry is configured to obtain the information using the power of the battery while the electronic device is in the standby state.

3. The electronic device of claim 2, further comprising:
a display panel configured to be driven based on the power signal of the power circuitry; and
one or more thermoelectric elements comprising at least one electrode attached to the display panel and configured to convert a thermal energy generated by the display panel to an electric energy.

4. The electronic device of claim 3, wherein the battery is configured to store the electric energy generated from the one or more thermoelectric elements.

5. The electronic device of claim 3, wherein the one or more thermoelectric elements are attached to a surface of light emitting diodes (LEDs) included in the display panel.

6. The electronic device of claim 1, further comprising:
a display panel driven based on the power signal of the power circuitry;
wherein the control circuitry is configured to cause the electronic device to:
disconnect, based on identifying the event, the electrical connection between the first port and the power circuitry by controlling the switch to reduce a power consumption of the display panel.

7. The electronic device of claim 1, wherein the control circuitry is configured to cause the electronic device to:
establish, based on obtaining the information indicating detection of the external object from the sensor, the electrical connection between the first port and the power circuitry by controlling the switch to enable the external electronic device connected to the one or more second ports.

8. The electronic device of claim 1, wherein the control circuitry is configured to cause the electronic device to:
control, based on obtaining the information indicating detection of the external object spaced apart from the electronic device by a distance less than a threshold distance from the sensor, the switch to resume providing the power through the one or more second ports.

9. The electronic device of claim 1, wherein the switch includes a relay switch configured to establish or disconnect the electrical connection based on movement of a conductive structure comprising a conductive material.

10. The electronic device of claim 1, wherein the wired interface is configured to relay data communication between external electronic devices connected to the second ports including a universal serial bus (USB).

11. The electronic device of claim 1, wherein the power circuitry includes rectification circuitry connected to the first port through the switch and configured to rectify the alternating current signal.

12. A method of operating an electronic device, wherein the electronic device includes power circuitry connected to a first port configured to receive an alternating current signal, a switch configured to control an electrical connection between the first port and the power circuitry, a wired interface configured to control one or more second ports configured to provide a power to an external electronic device based on a power signal of the power circuitry, a sensor, and control circuitry configured to control the switch using the sensor, the method comprising:
identifying, based on the electronic device in an enabled state, an event to switch a state of the electronic device from the enabled state to a standby state;
controlling, based on identifying the event, the switch to cease providing of the power through the one or more second ports;
obtaining, while the electronic device is switched to the standby state based on the controlling of the switch, information from the sensor; and
controlling, based on obtaining the information indicating detection of an external object from the sensor, the switch to resume providing the power through the one or more second ports.

13. The method of claim 12, wherein the obtaining comprises:
obtaining the information using the power of a battery of the electronic device configured to be charged based on the power signal of the power circuitry, while the electronic device is in the standby state.

14. The method of claim 13, wherein the battery is configured to store an electric energy generated from one or more thermoelectric elements attached to a display panel for changing a thermal energy generated by the display panel of the electronic device to the electric energy.

15. The method of claim 12, wherein the controlling the switch to resume providing the power comprises:
disconnecting, based on identifying the event, the electrical connection between the first port and the power circuitry by controlling the switch to reduce a power consumption of the display panel of the electronic device.

16. The method of claim 12, wherein the controlling the switch to resume providing the power comprises:
establishing, based on obtaining the information indicating detection of the external object from the sensor, the electrical connection between the first port and the power circuitry by controlling the switch to enable the external electronic device connected to the one or more second ports.

17. The method of claim 12, wherein the controlling the switch to resume providing the power comprises:
controlling, based on obtaining the information indicating detection of the external object spaced apart from the electronic device by a distance less than a threshold distance from the sensor, the switch to resume providing the power through the one or more second ports.

18. A display device comprising:
power circuitry configured to receive an alternating current signal;
a switch configured to control transmission of the alternating current signal to the power circuitry;
a battery configured to be charged based on a power signal output from the power circuitry in an enabled state;
a display configured to output an image based on the power signal;
a wired interface including one or more ports configured to output at least a portion of the power signal;
a sensor; and
control circuitry configured to be driven based on the battery in a standby state different from the enabled state,
wherein the control circuitry is configured to cause the display device to,
disable the power circuitry by controlling the switch to switch from the enabled state to the standby state;
in the standby state that transmission of the power signal to the display and the wired interface is ceased based on the disabled power circuitry, obtain information from the sensor; and
enable the power circuitry by controlling the switch based on obtaining the information indicating detection of an external object from the sensor.

19. The display device of claim 18, wherein the power circuitry includes rectification circuitry configured to rectify the alternating current signal,
wherein the rectification circuitry receives the alternating current signal through the switch.

20. The display device of claim 18, wherein the switch includes a relay switch configured to establish or disconnect the electrical connection based on movement of a conductive structure.
